(19) United States
(12) Patent Application Publication
(10) Pub. No.: US 2025/0383219 A1
(43) Pub. Date: Dec. 18, 2025

(54) SENSOR HOLDING DEVICE

(71) Applicant: Sartorius Stedim Biotech GmbH, Göttingen (DE)

(72) Inventors: Alexander Christie, Stonehouse Gloucestershire (GB); Björn Nickel, Guxhagen (DE); Thomas Regen, Göttingen (DE)

(73) Assignee: Sartorius Stedim Biotech GmbH, Göttingen (DE)

(21) Appl. No.: 18/877,235

(22) PCT Filed: Jun. 19, 2023
(86) PCT No.: PCT/EP2023/066356

§ 371 Date: Dec. 19, 2024

(30) Foreign Application Priority Data
Jun. 20, 2022 (DE) 20 2022 001 407.4

(51) Int. Cl. G01D 11/30; G01F 15/18

(52) U.S. Cl. CPC G01D 11/30; G01F 15/18

(57) ABSTRACT

A sensor holding device holds a sensor device and includes a holding body configured for holding the sensor device and the holding body includes a sensor holding device-side engaging means for engaging with a sensor device-side engaging means of the sensor device when the sensor device is held by the holding body, and a securing means connected to the holding body for securing the sensor device at the holding body that is moveable relative to the holding body to a first position and to a second position.

The present disclosure relates to a sensor holding device for holding a sensor device, and a system comprising a sensor holding device and a sensor device held by the sensor holding device.

Flow measurements are performed in pipe and hose systems in a great number of processes in the automation of industrial or technical laboratory processes. To this end, sensor devices, such as e.g. flow meters, are installed in all places in which the current delivery in the pipe or hose network is to be detected or the throughput is to be checked and further processed. Along with temperature, pressure and force, flow measurement constitutes one of the most important variables in industrial metrology and is an essential foundation of process automation.

In automated processes, the flow measurements vary depending on the method of measurement and the medium to be measured. A distinction is made between mechanical/volumetric, thermal, acoustic, magnetic/inductive, optical, gyroscopic or differential pressure/congestion methods. What all of the methods have in common, however, is the recording of certain physical characteristics, e.g., temperature, pressure, sound, acceleration, rotational speed, etc., via a measurement sensor.

In closed pipe or hose line systems, the flow measurements are divided into two subgroups based on medium and output signal, namely volumetric flow and mass flow. Furthermore, depending on the measurement setup, a distinction is made between so-called clamp-on sensors from in-line measurements. In the in-line measurements, the measurement sensors are mounted in the flow profile of the medium to be measured, whereas the clamp-on sensor is placed from the outside onto a pipe or hose and clamped.

An exemplary clamp-on sensor is described in JP 04940384 B1. It discloses an ultrasound flowmeter in which a hose through which the fluid to be measured flows is placed into a hinged measuring device and fixed in place by pressing the measuring device together. Through the deformation of the hose, the flow profile of the medium to be measured is altered into a nearly rectangular profile. However, as a result of fluctuations in the density and thickness of the hoses used as well as the resulting fluctuations in the internal cross section, severe measurement inaccuracies can occur when determining the volumetric flow. Also, due to the stress acting on the clamp-on sensor caused by deformation of the hose, the quality of measurements are further negatively affected. Consequently, the reproducibility of the measurement results and the calibration of the overall system are greatly impaired.

In order to avoid the above drawbacks, a clamp-on sensor not deforming the hose may be provided. However, measurements of a respective sensor may lack reproducibility because the sensor may easily be moved or shifted along the hose. Therefore, it requires fixation so that the sensor is held in place with respect to the hose.

Yet, it has been found that if a clamp-on sensor receives strain or stress from an external structure such as a mounting rack or mounting system, measurements may also be impaired. That is because stress on the housing, in particular compression, tension and/or sheer stress, may lead to inaccurate measurements due to marginal but still critical deformation and/or orientation changes of sensing parts of the sensor.

It is therefore an object of the present invention to provide a sensor holding device for holding a sensor device, in particular a clamp-on flow measurement sensor, with substantially no, but at least reduced, strain and/or stress on the sensor device for allowing improved measurement results and reproducibility of measurements.

### SUMMARY OF THE INVENTION

The invention is defined by the subject-matter of the independent claims. Preferred embodiments are defined in the dependent claims.

One aspect of the present invention relates to a sensor holding device for holding and/or retaining a sensor device, in particular a clamp-on flow measurement sensor, the sensor holding device comprising: a holding body configured for holding the sensor device, wherein the holding body comprises: a sensor holding device-side engaging means for engaging with a sensor device-side engaging means of the sensor device when the sensor device is held by the holding body; and a securing means connected to the holding body for securing the sensor device at the holding body, the securing means being moveable relative to the holding body to a first position and to a second position, wherein the securing means moved into the first position allows placing the sensor device onto the holding body and removing the sensor device from the holding body, and wherein the securing means moved into the second position and the sensor holding device-side engaging means engaging the sensor device-side engaging means (together) restrict relative movement of the sensor device along three directions with respect to the holding body such that the sensor device is secured at the holding body.

The sensor holding device may comprise one or more engaging means. Preferably, said sensor holding device-side engaging means is/are configured to mate with one or more complementary engaging means of the sensor device when the sensor device is held by the sensor holding device so that the sensor device is held in place.

Preferably, the sensor device is substantially not subject to strain and/or stress when held by the sensor holding device. In particular, when being held by the holding device, the sensor device receives substantially no normal stress, such as compression or tension acting perpendicular to an outer surface of a housing of the sensor device, and/or no shear stress, i.e. stress acting parallel to an outer surface of a housing of the sensor device. Accordingly, the holding body is preferably configured to hold the sensor device substantially without inducing stress and/or strain to the sensor device in order to not negatively affect accuracy and/or reproducibility of measurements. That is, any stress and/or strain still acting on the sensor device, e.g. due to gravity, are preferably reduced to an extent that the measurements are not negatively affected by said stress and/or strain.

Ideally, the sensor device, when being held by the sensor holding device, is restricted to move further than approximately 3 mm in one or more directions. Most preferably, restriction of movement corresponds to allowing movement of less than approximately 1.5 mm, e.g. approximately 0.6 mm, in each direction. This allows a certain tolerance of deviations of the orientation, sizing and/or positioning of the sensor holding device with respect to the sensor device while still providing a sufficient fixation of the sensor device with respect to the hose in which the fluid to be measured flows.

Preferably, the sensor holding device-side engaging means and the securing means are configured to partially enclose the sensor device so as to restrict movement of the sensor device relative to the sensor holding device. Advantageously, a plurality of sensor holding device-side engaging means are provided so that movement in a plurality of directions is restricted.

According to a particular example, the holding body of the sensor holding device includes a base portion for supporting the sensor device, wherein the securing means is connected to said base portion. Preferably, the securing means is in a relaxed or initial state in the second position and may be moved and/or displaced into the first position by an external force. For example, a user may apply pressure on a part of the securing means in order to transfer the securing means into the first position, in particular in order to be able to insert a sensor device into the sensor holding device. From the first position, the securing means may be moved into the second position, for example by an external force or, preferably, by a reset force, e.g. applied by a spring member and caused by forcing the securing means from the second position into the first position.

Most preferably, the securing means is connected to the base portion by a living hinge mechanism. A living hinge or integral hinge is a thin flexible hinge (flexure bearing) made from the same material as the two rigid pieces it connects. It is typically thinned or cut to allow the rigid pieces to bend along the line of the hinge.

A living hinge mechanism is particularly advantageous as it allows movement of the securing means from the first position to the second position and vice versa by flexion of an elastic connecting part between the securing means and the base portion. This avoids necessity of a complicated hinge mechanism including multiple parts and assembly effort. Advantageously, the living hinge mechanism is designed such that the securing means is moved from the first position to the second position by forces resulting from the flexion of the elastic connecting part when the securing means is moved into the first position. A living hinge mechanisms has the further advantage that the two rigid parts to be moved relative to one another may be formed integrally and/or from the same material and/or within the same manufacturing step.

Advantageously, the sensor holding device-side engaging means comprises or constitutes at least one projection, wherein the at least one projection is configured to restrict relative movement of the sensor device with respect to the holding body in at least one direction. For example, a sensor holding device-side engaging means may include a projection against which a part of a housing of the sensor device may abut so that the sensor holding device-side engaging means hinders a further relative movement of the sensor device.

In particular, the sensor holding device-side engaging means may comprise a projection configured to engage with the sensor device-side engaging means comprising a recess and/or a slot and/or a notch to restrict movement of the sensor device in a direction for removing the sensor device from the holding body, wherein the direction for removing may be a direction perpendicular to a surface of the base portion configured to support a lower or base side of the sensor device. Similarly, the sensor holding device-side engaging means may comprise a recess and/or a slot and/or a notch configured to engage with the sensor device-side engaging means comprising a projection to restrict movement of the sensor device in a direction for removing the sensor device from the holding body. Accordingly, it is preferred that the sensor holding device-side engaging means and the sensor device-side holding means comprise substantially complementary shapes and/or shapes with a lock-and-key fit. Respective engaging means may—together with the securing means-prevent the sensor device from being removed unintentionally from the sensor holding device.

Advantageously, the holding body is a single piece and/or formed integrally and/or is monolithic. Preferably, the securing means is formed integrally with the base portion; and/or the sensor holding device-side engaging means is formed integrally with the base portion. These have the advantage of reduced manufacturing and assembly effort. Also, resilience and/or mechanical properties may be designed according to needs, for example a robust connection between the base portion and the sensor holding device-side engaging means and/or a flexible yet enduring connection between the securing means and the base portion.

Particularly advantageous is if the holding body is formed by additive manufacturing and/or 3D printing and/or rapid prototyping, in particular by selective laser sintering, SLS. Selective laser sintering uses a laser as the power source to sinter powdered material (typically nylon or polyamide), aiming the laser automatically at points in space defined by a 3D model, binding the material together to create a solid structure. In this way, even complex shapes may be manufactured as a single part. SLS offers a high quality product in a cost effective manner, in particular for small batches. That is for example because no mould is needed, so that a sensor holding device manufactured by additive manufacturing, in particular SLS, may be brought to market faster and/or at lower cost, in particular for low quantities. Furthermore, mechanical properties may be affected and/or influenced by different layer orientations in additive manufacturing, in particular SLS. This is particularly advantageous if certain portions of the sensor holding device require a certain rigidity and/or flexibility, for example portions which are moved or flexed during use. Also, additive manufacturing, in particular SLS, allows the production to be adapted easily and quickly, e.g. if the design of the holding body is required or wished to be updated and/or changed. The holding body may alternatively be formed by other manufacturing methods such as injection molding or subtractive manufacturing.

Preferably, the holding body comprises or consists of polyamide, in particular PA12 (PA2200), in particular PA12 fused from granulated material using selective laser sintering. PA12 includes advantageous mechanical characteristics such as stress tolerance and flexibility.

The holding body may be surface treated by chemical vapor smoothing and/or vibro-polishing and/or media tumbling. In particular, a treated surface may have an improved haptic and/or optic and/or may be more tolerable with respect to chemicals, fluids and dust.

Particularly advantageous is if the sensor holding device is configured to allow use of the sensor device when the sensor device is held by the sensor holding device, in particular allowing coupling of a pipe and/or hose line to the sensor device. For example, when the sensor device is held by the sensor holding device, a user may be able to open a lid or cover of the sensor device for mounting the sensor device to a tube and/or pipe and/or hose line or vice versa. In particular, one or more elements, such as latches and/or snap-fit rockers, securing the lid or cover may be accessible when the sensor device is held by the sensor holding device. This way, the tube and/or pipe and/or hose line on which (flow) measurements are to be performed may be coupled with the sensor device when the sensor device is held (in place) by the sensor holding device. Also connection of one or more cables to the sensor device, access to one or more switches and/or buttons of the sensor device and/or recognizing type and/or serial number of the sensor device are preferably allowed when the sensor device is being held by the sensor holding device.

The sensor holding device may be configured to be mounted to a rack and/or frame, in particular a rack and/or frame of a fluid measurement system. This way, the sensor device may be advantageously fixed relative to the tube and/or fluid pipe. For example, the holding body may comprise one or more mounting means such one or more holes and/or mounting eyes and/or clips. Preferably, said one or more mounting means are provided at the base member of the holding body.

The sensor device comprises or is one or more of: a pressure sensor, a temperature sensor, a flow sensor and/or an optical sensor.

The sensor device may be configured to perform measurements on a hose and/or pipe having internal diameters from approximately 1/10″ to 2″, preferably from approximately ¼″ to 1″, e.g. ⅜″ or ½″. For pipe and hose diameters, the unit of measure of “continues to be the standard for a person skilled in the art. 1” (inch) corresponds to 1 in (inch) which, in turn, corresponds to 25.4 mm. These are also the common hose and plastic pipe diameters that are used as disposable (single-use) articles in the pharmaceutical, chemical or foodstuff technology industry as well as in technical laboratories.

A further aspect of the present invention relates to a sensor holding device for holding and/or retaining a sensor device, in particular a clamp-on flow measurement sensor, the sensor holding device comprising: a holding body configured for holding the sensor device, wherein the holding body comprises: a securing means connected to the holding body for securing the sensor device at the holding body; wherein the holding body is fabricated using an additive manufacturing method, in particular selective laser sintering (SLS).

The preferred features, properties and considerations laid out with respect to the previous aspect also apply, mutatis mutandis, with respect to this aspect.

In particular, the holding body may be a single piece and/or formed integrally and/or monolithic.

Also, the securing means may be moveable relative to the holding body to a first position and to a second position, wherein the securing means moved into the first position allow placing the sensor device onto the holding body and removing of the sensor device from the holding body, and wherein the securing means moved into the second position restrict relative movement of the sensor device along at least one direction with respect to the holding body such that the sensor device is secured at the holding body.

The holding body may further comprise: a sensor holding device-side engaging means for engaging with a sensor device-side engaging means of the sensor device when the sensor device is held by the holding body; and wherein the securing means moved into the second position and the sensor holding device-side engaging means engaging the sensor device-side engaging means restrict relative movement of the sensor device along three directions with respect to the holding body such that the sensor device is secured at the holding body.

Moreover, the sensor device is preferably substantially not subject to strain and/or stress when held by the sensor holding device. More specifically, advantageously, the holding body is configured to hold the sensor device substantially without inducing stress and/or strain to the sensor device, in particular in order not to negatively affect accuracy of measurements.

Restriction of movement corresponds to allowing movement of less than approximately 3 mm in one or more directions, more preferably of less than 1.5 mm, e.g. 0.6 mm.

Preferably, the sensor holding device-side engaging means and the securing means are configured to partially enclose the sensor device so as to restrict movement of the sensor device relative to the sensor holding device.

Also, the holding body may include base portion for supporting the sensor device, wherein the securing means is connected to the base portion, preferably by a living hinge mechanism.

Advantageously, the sensor holding device-side engaging means may comprise at least one projection, wherein the at least one projection is configured to restrict relative movement of the sensor device with respect to the holding body in at least one direction.

In particular, the sensor holding device-side engaging means may comprise a projection configured to engage with the sensor device-side engaging means comprising a recess to restrict movement of the sensor device in a direction for removing the sensor device from the holding body.

For example, the sensor holding device-side engaging means may comprise a recess configured to engage with the sensor device-side engaging means comprising a projection to restrict movement of the sensor device in a direction for removing the sensor device from the holding body.

Also, the securing means may be formed integrally with the base portion; and/or the sensor holding device-side engaging means may be formed integrally with the base portion.

Moreover, the holding body may comprise or consist of polyamide, in particular PA12 (PA2200), in particular PA12 fused from granulated material using selective laser sintering (SLS).

If preferred, the holding body may be surface treated by chemical vapor smoothing and/or vibro-polishing and/or media tumbling.

The sensor holding device may also be configured to allow coupling of a pipe to the sensor device when the sensor device is held by the sensor holding device and/or to be mounted to a rack, in particular a rack of a fluid measurement system.

Moreover, the sensor device may comprise one or more of: fluid sensor, ultrasonic sensor, flow sensor, optical sensor.

Yet a further aspect of the present invention relates to a system comprising a sensor holding device according to one of the foregoing aspects and a sensor device configured to be held by the sensor holding device.

Yet a further aspect relates to a method of manufacturing a sensor holding device according to one of the foregoing aspects using an additive manufacture technique, in particular using selective laser sintering.

The method may include slicing a 3D model of the sensor holding device into a plurality of layers and subsequently printing the layers in order to build the holding body of the sensor holding device.

Preferably, the method comprising fabricating the sensor holding device as a single piece and/or integrally and/or monolithic.

Advantageously, the method includes fusing polyamide, in particular PA12 (PA2200), in particular granulated and/or powdered PA12, using selective laser sintering (SLS) and forming the holding body of the sensor holding device.

The present invention is further explained in detail by the following detailed description and the appended drawings, in which particular embodiments are illustrated by way of example, wherein the present invention is in no way limited by these particular embodiments.

### BRIEF DESCRIPTION OF THE DRAWINGS

FIG. 1 shows a system comprising a sensor holding device and a sensor device held by the sensor holding device;

FIG. 2 shows an exemplary sensor holding device;

FIG. 3 shows a further exemplary sensor holding device including mounting means;

FIG. 4 shows a cross section of the exemplary sensor holding device of FIG. 3 along line A-A.

### DESCRIPTION OF PARTICULAR EMBODIMENTS

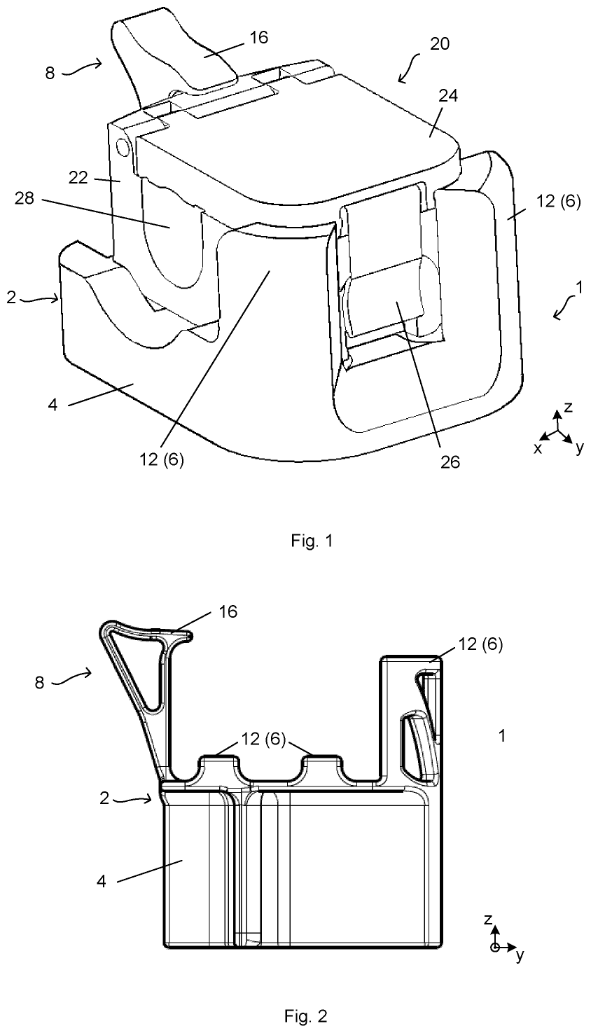

FIG. 1 shows a system comprising an exemplary sensor holding device 1 and an exemplary sensor device 20 held by the sensor holding device 1. The senor device is held and/or retained by the sensor holding device 1, specifically by a holding body 2 thereof being in abutting relationship with at least a part and/or surface of the housing 22 of the sensor device 20.

Preferably, the holding body 2 of the sensor holding device 1 comprises one or more engaging means or members 6 (as particular sensor holding device-side engaging means or members) configured to engage with one or more engaging means or members of the sensor device 20 (as particular sensor device side engaging means or members).

According to this example, the sensor holding device 1 comprises two projections 12 substantially protruding from neighboring corners of a base portion 4 (lower side of the holding body 2 in FIG. 1). Each one of the projections 12 of the sensor holding device 1 shown in FIG. 1 are configured to hinder and/or restrict movement of the sensor device 20 in two directions, i.e. +x direction and +y direction and −x direction and +y direction, respectively. Accordingly, both projections 12 together only allow movement of the sensor device 20 with respect to the sensor holding device 1 in the −y direction in the y-x plane. A respective projection may have a height (i.e. a dimension along z direction) of between approximately 5 mm and 60 mm and/or a width and/or length (i.e. a dimension along y/x direction, respectively) of between approximately 2 mm and 60 mm.

The sensor holding device 1 may further comprise at least one securing means or member 8, wherein the securing means 8 is configured to hinder and/or restrict movement of the sensor device 20 in at least one direction, wherein said at least one direction particularly is or includes a direction in which the sensor device 20 may be removed from the sensor holding device 1. In the example shown in FIG. 1, the securing means 8 comprises at least one hook portion 16, which is configured to abut and/or overlap a part of an upper portion of the sensor device 20 and, thus, hinders and/or restricts movement of the sensor device 20 substantially in the z direction particularly to avoid removal of the sensor device 20 from the (holding body 2 of) the sensor holding device 1. A respective securing means particularly may have a length (i.e. a dimension along z direction) of between approximately 5 mm and 60 mm and/or a width and/or depth (i.e. a dimension along x/y direction, respectively) of between approximately 2 mm and 20 mm.

The securing means 8 is preferably configured to be movable and/or displaceable relative to a base portion 4 of the holding body 2 so as to be arrangeable in at least a first position and a second position. Alternatively, only a part and/or portion of the securing means 8 may be movable and/or displaceable. In the first position, the securing means 8 is arranged so as to allow a coupling between a sensor device 20 with the sensor holding device 1 so as to be held and/or retained by the sensor holding device 1.

Advantageously, when the securing means 8 is located in the second position, the securing means 8 is in a relaxed and/or initial or standby state. In particular, the second position may correspond to a manufactured position of the securing means 8. In the example shown in FIG. 1, the securing means 8 is shown arranged in the second position and, in the second position, particularly prevents and/or hinders the sensor device 20 from being removed from the (holding body 2) of the sensor holding device 1.

In the first position, the securing means 8 does substantially not prevent and/or hinder the sensor device 20 from being removed from the (holding body 2) of the sensor holding device 1. Accordingly, placement of the sensor device 20 onto the holding body 2 of the sensor holding device 1 is allowed when the securing means 8 is in the first position.

The securing means 8 may be moved and/or displaced from the second position to the first position by means of external force, e.g. a thumb of a user or a tool applying pressure on a part of the securing means 8.

Alternatively or in addition, the securing means 8 may be forced or biased by the housing 22 of the sensor device 20 into the first position due to a relative movement of the sensor device 20 in the direction to the holding body 2 of the sensor holding device 1, similar to a snap-fit mechanism. This way, coupling of the sensor device with the sensor holding device 1 is simplified as no additional action to displace the securing means 8 into the first position is required.

The movement and/or displacement mechanism of the securing means 8 may be of different kind. For example, the securing means 8 may be connected to the base portion 4 by means of a pivot pin and/or a sliding mechanism. As a further example, the securing means 8 may be connected to the base portion by means of a living hinge mechanism or integral hinge mechanism. A respective living hinge mechanism is described with respect to FIG. 4 in more detail.

The sensor device 20 is preferably held substantially without induced stress and/or strain by the sensor holding device 1 in order to not negatively affect accuracy and/or reproducibility of measurements of the sensor device 20.

Advantageously, the sensor holding device 1 is configured to hold the sensor device so as to allow movement of the sensor device 20 by a maximum of approximately 3 mm in one or more directions. Most preferably, allowed movement is less than approximately 2 mm, e.g. approximately 0.8 mm or less. This way, a certain tolerance of deviations of the orientation, sizing and/or positioning of the sensor holding device 1 with respect to the sensor device 20 is allowed. Thus, even if the sensor device 20 is displaced or receives a force leading to displacement, e.g. by a tube or hose to which the sensor device 20 is connected to, the sensor device 20 is substantially not subject to strain and/or stress when held by the sensor holding device. That is, any stress and/or strain acting on the sensor device 20 when being held by the sensor holding device 1, e.g. due to gravity, are preferably reduced to an extent that the measurements are not negatively affected by said stress and/or strain.

Referring to the example of FIG. 1, the distance in the x direction between the two projections 12 may be up to approximately 3 mm greater than the distance between two opposing sides of the sensor device 20 in the x direction so that the sensor device 20 is held by the sensor holding device 1 sufficiently secure but not hold the sensor device 20 as tight as to induce strain and/or stress to the sensor device 20.

Similarly, the securing means 8 is positioned with respect to the engaging means 6 and/or the base portion 4 in order to allow a movement of the sensor device 20 of less than approximately 3 mm. In the example shown in FIG. 1, the securing means 8 allows movements in the −y direction and the +z direction but restricts further movement(s).

Advantageously, the (sensor holding device-side) engaging means 6 and/or the securing means 8 are positioned and/or formed such that the use and/or handling of the sensor device 20 is warranted while being hold by the sensor holding device 1.

For example, referring to the exemplary sensor device 20 shown in FIG. 1, at least one lid 24 may be opened in order to enable access to a tube channel 28 so that the sensor device 20 may be coupled with and/or clamped-on a tube or hose, at which measurements are to be performed.

In this example, for being able to open the lid 24, access to a latch 26 as part of a fixing mechanism for the lid 24 needs to be allowed. Therefore, the holding body 2 is preferably formed such that a respective area and/or portion of the sensor device is laid open and/or not covered by the holding body 2.

In the particular example, the projections 12 are spaced apart so as to form a gap or recess between them for at least partly accessing the latch 26. A respective gap may have a width between approximately 5 mm and 50 mm.

Similarly, the securing means 8 particularly is positioned and/or formed in order to not hinder and/or limit opening and closing of the lid 24 of the sensor device 20. Also, access to e.g. connectors and/or buttons and/or display means of the sensor device 20 is preferably provided. It is particularly advantageous if the securing means 8 and the sensor holding device-side engaging means 6 are configured to prevent and/or restrict movement of the sensor device 20 even when the lid 24 is open. This may be achieved if, for example, the securing means 8 and the sensor holding device-side engaging means 6 are configured to engage the sensor device-side engaging means, which is/are located at parts of the sensor device 20 different than the lid 24 such as, for example, a lower lip and/or section of the housing 22 of sensor device 20.

The securing means 8 and the engaging means 6 shown in FIG. 1 are merely illustrative examples. In particular, the sensor holding body 2 of the sensor holding device 1 may have one or more additional and/or different engaging means or members 6 for holding and/or retaining a sensor holding device 20. Further examples of one or more engaging means 6 are described with respect to FIGS. 2 to 4. The same applies for the securing means 8. Furthermore, properties and aspects of the features described above may also apply to the features of the further figures.

FIG. 2 shows a side view of another exemplary sensor holding device 1. Similar as to the sensor holding device 1 of FIG. 1, the holding body 2 may comprise projections 12 on neighboring corners, which act as or are part of a sensor holding-side engaging means or member 6. Also, a securing means or member 8 comprising a hook portion 16 positioned on the substantially opposite side to the two projections 12 may be provided. Together, the securing means 8 and the engaging means 6 provide securing of a sensor device 20 at the holding body 2 of the sensor holding device 1.

In addition, the particular example of a sensor holding device 1 in FIG. 2 may comprise one or more, e.g. four, additional engaging means or members 6 in the form of projections 12 for supporting and/or engaging with a lower part of substantially opposing side surfaces of a housing 22 of a sensor device 20 held by the sensor holding device 1.

The additional projections 12 in particular ensure that a rotation of the sensor device around the z axis is prevented or at least limited to a certain degree when being held by the sensor holding device 1.

The holding body 2 of the sensor holding device 1 is preferably manufactured by additive manufacturing. A particularly preferred additive manufacturing technique is selective laser sintering (SLS), which includes fusion of particles to an integral component. Additive manufacturing e.g. allows manufacturing of complex shapes with reduced effort and use of material. Also, the holding body 2 of the sensor holding device 1 particularly may be manufactured by additive manufacturing of polyamide such as PA12 (PA2200), which is particularly suitable for SLS and offers preferred material properties, in particular with respect to rigidity, flexibility and haptic. Also, PA12 may be subject to surface and/or dying processes for a further improved product as described further below.

The holding body 2 of the sensor holding device 1 is advantageously manufactured as a single part and/or unitarily and/or integrally and/or monolithic. In particular, integrally forming the base portion 4 with the securing means 8 and/or one or more engaging means 6 is advantageous. A respective holding body 2 requires no or minimal assembly effort. Also, it includes advantageous properties with respect to resilience and/or robustness and/or flexibility because no attachment points, e.g. by welding or bonding, are present, which may be subject to failure. This particularly applies with respect to the connection portion(s) between the base portion and the securing means 8/engaging means 6.

As can be seen in FIG. 2, the securing means 8 of the holding body 2 is of a rather complex design, which would require a sophisticated and expensive casting mold for injection molding and/or manufacturing of different parts, which are to be assembled to form the holding body. For example, the recess in the upper portion of the securing means 8 as well as the protruding hook portion 16 constitute such critical design features.

For similar reasons, subtractive manufacturing of holding body 2 as shown in FIG. 2 or similar would include certain disadvantages over additive manufacturing, e.g. because it would involve a rather high waste of removed material. In addition to the advantages laid out in the foregoing, additive manufacturing, in particular SLS, is further advantageous in that a faster turnaround for production and qualification may be obtained, in particular because no or less tooling is required. Also, compared to other manufacturing techniques, in particular injection moulding, certain limitations in the design of the holding body 2, such as wall thickness consistency, draft angle(s), split line(s) and/or overhang(s), do not or at least to a lower extend apply in additive manufacturing, in particular SLS. These and further aspects make additive manufacturing techniques advantageous for manufacturing of the sensor holding device 1, in particular for smaller batches.

The exemplary sensor holding device 1 shown in FIG. 2 comprises a holding body 2 having a base portion 4 is particularly configured to act as spacer and/or standoff and/or distance piece for mounting the sensor device 20 with a predefined and/or predefinable distance to a device such as a mounting rack to which the sensor holding device 1 may be mounted. With appropriate dimensioning of the base portion 4, a particular position of a hold sensor device 20 in a fluid measurement system may be obtainable without the need of further connection elements.

For example, dimensions of the base portion 4 may be as follows: z direction (height) of approximately between 2 mm and 50 mm, y direction (length) and/or x direction (width) of approximately between 10 mm and 100 mm.

Preferably, the base portion 4 of the holding body 2 may be solid or may be partly hollow. For example, one or more recesses and/or one or more holes and/or one or more channels may be present in the base portion 4. This is advantageous as it reduces the amount of material used and, therefore, weight and manufacturing costs and effort.

Furthermore, respective structures may be used as mounting means or members 6 for mounting the holding body 2 to a frame or rack of a fluid measurement system.

Similarly, as shown in FIG. 2, engaging means or members 6 and securing means or members 8 may comprise one or more recesses, e.g. for material reduction and/or for obtaining an advantageous property such as flexibility.

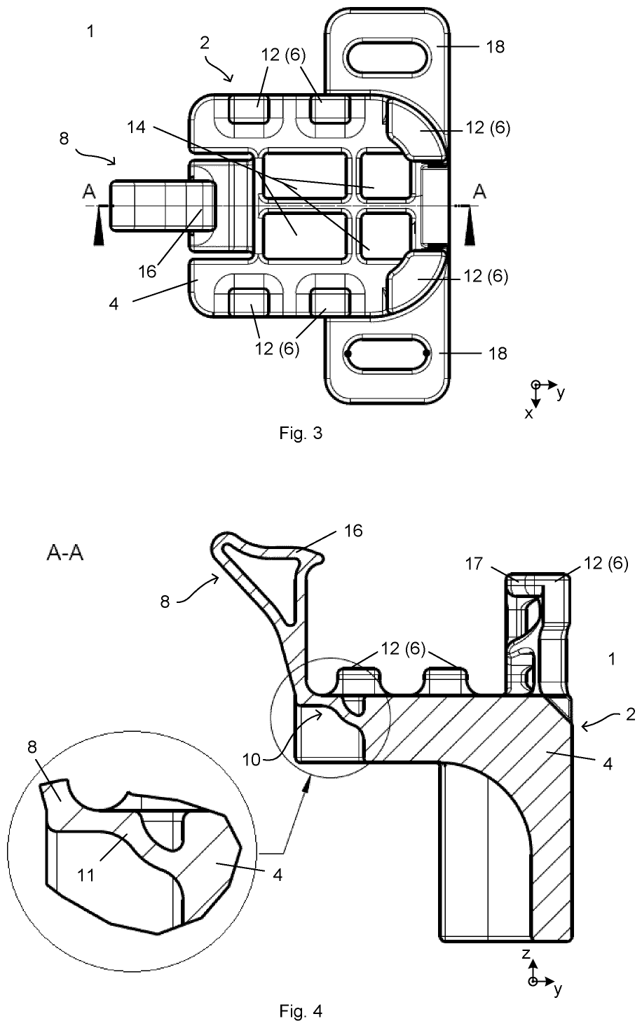

FIG. 3 shows a top view of a further exemplary sensor holding device 1. The sensor holding device 1 of FIG. 3 comprises a plurality of engaging means or members 6.

As can be seen in the top view, four projections 12 specifically are provided substantially on side portions of the holding body 2 on substantially opposed sides along the x direction substantially and form a pocket for receiving a sensor device 20. Said four projections 12 in particular limit and/or restrict movement of a sensor device 20 in the x direction and/or rotation of the sensor device 20 around the z axis.

The sensor holding device 1 may further comprise two or more protrusions 12 on neighboring corners on the lateral side (e.g. right hand side end) of the base portion 4. Said particular protrusions 12 are described in more detail further below with respect to FIG. 4.

The sensor holding device 1 further comprises a securing means or member 8 configured to restrict movement in the −y direction and, specifically by means of at least one overhanging hook portion 16, hinders or at least substantially impedes removal of a sensor device 10 from the holding body 2.

Further illustrated are one or more mounting means or members 18 of the holding body 2, which advantageously provide fastening and/or mounting of the sensor holding device 1 to a rack and/or frame and/or fixed element, in particular as part of a fluid measurement system.

As shown in FIG. 3, an exemplary mounting means or member 18 may comprise at least one through hole, preferably an elongated hole, so that the position of the sensor holding device 1 with respect to a hose and/or pipe may be fixed and/or adjusted. This way, the position and/or orientation of the sensor holding device 1 may be advantageously adapted so that a sensor device 20 held by the sensor holding device 1 substantially receives no strain and/or stress when coupled to a hose or pipe.

Additional and/or alternative mounting means or members 18 may comprise one or more of: a tab and/or a protrusion and/or a slot and/or a recess and/or a thread.

As shown in FIG. 3, the holding body 2 may comprise one or more, e.g. four, protrusions and/or recesses 14. As described with respect to FIG. 2, said recesses 14 may allow reduced material use and/or reduction of weight of the holding body 2.

In addition, recesses 14 may act as engaging means or members 6 so as to engage with correspondingly formed sensor device-side engaging means. In the example shown in FIG. 3, the recesses 14 are configured to engage with substantially rectangular projections protruding from a surface of a housing 22 of a sensor device 20. The same principle applies for one or more projections protruding from the base portion 4, which may engage one or more substantially complementary shaped recesses of the sensor device 20.

Accordingly, one or more recesses 14 may be provided in addition and/or in replacement of the illustrated projections 12 for restricting movement of sensor device 20 held by the sensor holding device 1.

The number and/or combination of projections and recesses provided to the holding body 2 may vary according to needs and design aspects of the sensor device 20 to be held by the sensor holding device 1. Preferably, a sufficient number and/or shape of such engaging means in order to provide a reliable securing of the sensor device while at the same time reducing manufacturing costs and allowing access to crucial areas and/or features of a held sensor device 20 is provided.

The sensor holding devices 1 illustrated in the figures of the present application relate to particular examples. However, other forms and/or features of sensor holding devices 1 may be in conformity with the claimed invention.

FIG. 4 shows a cross section of the exemplary sensor holding device 1 of FIG. 3 along line A-A.

The protrusion 12 substantially positioned on a corner of the base portion 4 (shown on the right hand side in FIG. 4) restricts movement of a held sensor device 1 in three directions: Movement in the −x direction and the +y direction is limited and/or restricted in the same way as the corresponding projections of the examples shown in FIGS. 1 and 2.

However, the projection shown in FIG. 4 particularly further limits and/or restricts movement also in the +z direction, i.e. a direction in which a held sensor device 20 may be removed from the holding body 2 of the sensor holding device 1. This is achieved by a protrusion and/or nose portion 17 substantially horizontally projecting from said projection 12 towards a center of the holding body 2 in a distance to the base portion 4. Said nose portion 17 particularly constitutes a particularly preferred engaging means or member, or at least a part thereof.

The nose portion 17 particularly is formed and/or positioned and/or oriented so as to engage a sensor device-side engaging means comprising a substantially complementary shape, such as a recess or a notch, in the housing 22 of a sensor device 20. The nose portion 17 may be similarly shaped as the hook portion 16 of the securing means 8 and/or may improve securing of a sensor device 10 at the holding body 2 of the sensor holding device 1.

Preferably, the holding body 2 comprises a further, substantially symmetrical projection on the neighboring corner in order to obtain an even further improved securing of the sensor device 10 (as shown in FIG. 3).

In view of the increased complexity of the holding body 2, in particular by comprising one or more overhanging features as e.g. the hook portion 16 or nose portion 17, additive manufacturing methods may be advantageous for the reasons laid out in the foregoing.

Further, particularly advantageous features of a sensor holding device 1 is shown in detail in FIG. 4, namely a living hinge mechanism 10 as movement and/or displacement mechanism of the securing means 8.

A living hinge or integral hinge particularly is a thin flexible hinge (flexure bearing) made from the same material as the two rigid pieces it connects, in case of the sensor holding device 1 of FIG. 4 the securing means 8 and the base portion 4. It may comprise a thinned or cut portion 11 to allow the rigid pieces to be displaced relative to one another without destruction.

A living hinge mechanism 10 as shown in FIG. 4 is particularly advantageous as it allows movement of the securing means 8 substantially from a first position to a second position and vice versa.

Specifically, at the same time, due to flexion of the thinned portion 11 between the securing means 8 and the base portion 4, a preferred living hinge mechanism 10 as the one shown in FIG. 4 provides a bias and/or an automatic or inherent reset of the securing means 8 from the first position to the second position when a force, which caused displacement of the securing means 8 from the second position to the first position, is removed from acting on the securing means 8.

Consequently, a sensor device 20 particularly is held securely by the holding body 2 of the sensor holding device 1 without requiring a further action by a user inserting the sensor device 20, such as moving the securing means 8 manually into the second position. Thus further improves ease and reliability of mounting of the sensor device 20 to the sensor holding device 1.

The design of the thinned portion 11 may be chosen and/or altered in accordance to the force intended to be required for displacing the securing means 8 from the second position to the first position. For example, it may be between approximately 1 mm and 8 mm thick.

Advantageously, the movement and/or displacement mechanism of the securing means 8 is designed so that the securing means 8 is preferably not moved by accident and/or unintentionally, e.g. whilst being transported and/or handled, to an extend that a held sensor device 20 may be removed and/or released and/or movement of a held sensor device 20 may no longer be sufficiently restricted. With respect to the exemplary sensor holding device 1 of FIG. 4, the living hinge mechanism 10, in particular the thinned portion 11, may be designed so that no unintended release and/or removal of a held sensor device 20 may occur, e.g. by providing a sufficient rigidity and/or resistance.

The design of the thinned portion 11 also greatly depends on the material the holding body 2 is made of. In particular forming the thinned portion 11 of PA12 (PA2200) provides advantageous material and manufacturing properties due to its characteristic rigidity and flexibility. Also, at least a portion of the holding body 2 manufactured of PA12 (PA2200) may be treated, e.g. dyed and/or surface treated, in order to obtain a desired quality. For example, the surface may be smoothed by chemical vapor smoothing, through which substantially sealed surface may be achieved. This is particularly advantageous for use of the holding body 2 in wet environments because any fluid coming into contact with the holding body 2 may not ingress into the inner parts thereof.

Moreover, the printing direction of the additive manufacturing process may be chosen according to needs. For example, the printing direction, i.e. the direction in which layers are formed on top of each other, may be chosen depending on orientation of the axis of the living hinge mechanism 10. In this respect, it has been found that a printing orientation in the +z direction is advantageous for robustness and behavior of a living hinge mechanism as shown in FIG. 4.

Accordingly, there particularly is disclosed a sensor holding device for holding a sensor device, in particular a clamp-on flow measurement sensor, the sensor holding device comprising: a holding body configured for holding the sensor device, wherein the holding body comprises: a sensor holding device-side engaging means for engaging with a sensor device-side engaging means of the sensor device when the sensor device is held by the holding body; and a securing means connected to the holding body for securing the sensor device at the holding body, the securing means being moveable relative to the holding body to a first position and to a second position, wherein the securing means moved into the first position allows placing the sensor device onto the holding body and removing the sensor device from the holding body, and wherein the securing means moved into the second position and the sensor holding device-side engaging means engaging the sensor device-side engaging means restrict relative movement of the sensor device along three directions with respect to the holding body such that the sensor device is secured at the holding body.

### REFERENCE LIST

1 sensor holding device
2 holding body
4 base portion
6 sensor holding device-side engaging means
8 securing means
10 living hinge mechanism
11 thinned portion
12 projection
14 recess
16 hook portion
17 nose portion
18 mounting means
20 sensor device
22 housing
24 lid
26 latch
28 tube channel

1.-35. (canceled)

36. A sensor holding device for holding a sensor device, comprising:
a holding body configured for holding the sensor device, wherein the holding body comprises:
a sensor holding device-side engaging means for engaging with a sensor device-side engaging means of the sensor device when the sensor device is held by the holding body; and
a securing means connected to the holding body for securing the sensor device at the holding body, the securing means being moveable relative to the holding body to a first position and to a second position,
wherein the securing means moved into the first position allows placing the sensor device onto the holding body and removing the sensor device from the holding body, and
wherein the securing means moved into the second position and the sensor holding device-side engaging means engaging the sensor device-side engaging means restrict relative movement of the sensor device along three directions with respect to the holding body such that the sensor device is secured at the holding body.

37. The sensor holding device of claim 36, wherein the sensor device is a clamp-on flow measurement sensor.

38. The sensor holding device of claim 36, wherein the sensor device is substantially not subject to strain and/or stress when held by the sensor holding device.

39. The sensor holding device of claim 36, wherein the holding body is configured to hold the sensor device substantially without inducing stress and/or strain to the sensor device.

40. The sensor holding device of claim 36, wherein restriction of movement corresponds to allowing movement of less than approximately 3 mm in one or more directions.

41. The sensor holding device of claim 36, wherein the sensor holding device-side engaging means and the securing means are configured to partially enclose the sensor device so as to restrict movement of the sensor device relative to the sensor holding device.

42. The sensor holding device of claim 36, wherein the holding body includes a base portion for supporting the sensor device, wherein the securing means is connected to the base portion by a living hinge mechanism.

43. The sensor holding device of claim 36, wherein the sensor holding device-side engaging means comprises at least one projection, wherein the at least one projection is configured to restrict relative movement of the sensor device with respect to the holding body in at least one direction.

44. The sensor holding device of claim 36, wherein the sensor holding device-side engaging means comprises a projection configured to engage with the sensor device-side engaging means comprising a recess to restrict movement of the sensor device in a direction for removing the sensor device from the holding body.

45. The sensor holding device of claim 36, wherein the sensor holding device-side engaging means comprises a recess configured to engage with the sensor device-side engaging means comprising a projection to restrict movement of the sensor device in a direction for removing the sensor device from the holding body.

46. The sensor holding device of claim 42, wherein:
the holding body is a single piece and/or formed integrally; and/or
wherein the securing means is formed integrally with the base portion; and/or
wherein the sensor holding device-side engaging means is formed integrally with the base portion.

47. The sensor holding device of claim 36, wherein the holding body is formed by additive manufacturing.

48. The sensor holding device of claim 47, wherein the holding body comprises or consists of polyamide.

49. The sensor holding device of claim 48, wherein the polyamide comprises PA12.

50. The sensor holding device of claim 48, wherein the holding body has been surface treated by chemical vapor smoothing, and/or vibro-polishing, and/or media tumbling.

51. The sensor holding device of claim 36, wherein the sensor holding device is configured to allow coupling of a pipe to the sensor device when the sensor device is held by the sensor holding device.

52. The sensor holding device of claim 36, wherein the sensor holding device is configured to be mounted to a rack or frame.

53. The sensor holding device of claim 52, wherein the rack or frame is part of a fluid measurement system.

54. The sensor holding device of claim 36, wherein the sensor device comprises one or more of: a pressure sensor, a temperature sensor, a flow sensor and/or an optical sensor.

55. A sensor holding device for holding a sensor device that is a clamp-on flow measurement sensor, the sensor holding device comprising:
a holding body configured for holding the sensor device, wherein the holding body comprises:
a securing means connected to the holding body for securing the sensor device at the holding body;
wherein the holding body is fabricated using an additive manufacturing method.
